(19) United States
(12) Patent Application Publication
(10) Pub. No.: US 2025/0340222 A1
(43) Pub. Date: Nov. 6, 2025

(54) Training Method for a Driving Assistance System for an Automated Lateral Guidance of a Motor Vehicle

(71) Applicant: Bayerische Motoren Werke Aktiengesellschaft, Muenchen (DE)

(72) Inventors: Jakob HUEMER, Muenchen (DE); Walter KAGERER, Muenchen (DE); Kathrin LEHMEYER, Muenchen (DE); Andreas SPAETH, Lindau (DE)

(21) Appl. No.: 18/867,632

(22) PCT Filed: May 2, 2023
(86) PCT No.: PCT/EP2023/061446

§ 371 Date: Nov. 20, 2024

(30) Foreign Application Priority Data
May 25, 2022 (DE) 10 2022 113 191.2

(51) Int. Cl. B60W 60/00; B60W 30/18; B60W 50/00

(52) U.S. Cl. CPC B60W 60/0053; B60W 30/18163; B60W 50/00; B60W 2050/0083; B60W 2554/4044; B60W 2556/20

(57) ABSTRACT

A training method is provided for a driving assistance system for an automated lateral guidance of a motor vehicle. The training method includes recording a trajectory of the motor vehicle when traversing a section while the driving assistance system for an automated lateral guidance is deactivated, where the section cannot be managed by the driving assistance system for an automated lateral guidance, and training the driving assistance system for an automated lateral guidance on the basis of the recorded trajectory such that the section can be managed by the driving assistance system for an automated lateral guidance after the training process.

### BACKGROUND AND SUMMARY

The present disclosure relates to a training method for a driver assistance system for automated lateral control of a motor vehicle. In addition or alternatively, a system for data processing or a data processing device is provided that is designed to carry out at least part of the method. In addition or alternatively, a motor vehicle, in particular automated, is provided with the data processing device. In addition or alternatively, a computer program is provided that includes commands that, when the program is executed by a computer, cause the computer to carry out the method at least partially. In addition or alternatively, a computer-readable medium is provided that contains commands that, when executed by a computer, cause the computer to carry out the method at least partially.

From DE 10 2018 204 069 A1, a method for the operation of a steering assistant and/or lane guidance assistant is known. The method includes determining performance data relating to a drop in performance of the steering assistant and/or lane guidance assistant during a large number of journeys of one or more first vehicles along a route, associating the performance data with position data in relation to a position along the route in connection with which the drop in performance occurred in each case; detection, on the basis of the performance data and the position data, of an accumulation of drops in performance of the steering assistant and/or lane guidance assistant at least at a certain position on the route; and determining adjustment data for an adjustment of at least one operating parameter and/or at least one boundary condition for the operation of the steering assistant and/or lane guidance assistant for a second vehicle when the second vehicle is driving at the certain position of the route.

In most cases, toll stations are places where a drop in performance of a driver assistance system for automated lateral guidance of a motor vehicle can be determined. Toll stations often have no lane markings on a certain part of the route. However, driver assistance systems for automated lateral guidance are usually based on lane markings in order to follow them. Such driver assistance systems can therefore only bridge a limited or short distance without lane markings, for example, using a track of vehicles ahead. This means that at toll stations, with such driver assistance systems the automated lateral guidance usually ends and a driver has to take over the lateral guidance manually, i.e., steer the vehicle himself.

Toll stations are mapped in maps, but only the location of the toll station and the lanes marked on the road. Here, too, continuous lateral guidance is not possible. In addition, it is possible to configure in the motor vehicle which payment systems the motor vehicle can use. However, it is currently not known which payment systems are offered in which lanes or what other restrictions exist (for example, height restrictions), so that the motor vehicle cannot determine which lanes it can or should use.

This means that there is currently no guidance variable for the lateral guidance driving assistance system at toll stations, so that it has to switch off when driving through the toll station. In addition, it is unclear which lanes of the toll station can be used by the motor vehicle.

Against the background of this prior art, it is the object of the present disclosure to specify a device and a method, each of which is capable of enriching at least the prior art described above. In particular, a possibility of being able to drive through the toll stations with automated lateral guidance even without a vehicle ahead is to be described.

The object is achieved by the features of the independent claim. The dependent claims have preferred developments of the invention as content.

The object is then achieved by a training method for a driver assistance system for the automated lateral guidance of a motor vehicle.

A driver assistance system can be understood as a device in the motor vehicle for supporting the driver in certain driving situations. In addition to hardware components, the driver assistance system can also have software components.

The driver assistance system for automated lateral guidance can be designed to make active interventions in the lateral guidance of the motor vehicle in order to keep the motor vehicle in the middle of a (driving) lane. The driving assistance system can also be referred to as a steering assistant and/or a lane guidance assistant.

A training method can be understood as a method in which the driver assistance system to be trained is trained or its functionality is expanded. This means that the driver assistance system is modified by means of the method in such a way that it is available or can be used in driving situations in which it could not be used (or not to the same extent) before the method was carried out.

The method may be a computer-implemented method, i.e., one or more or all of the steps of the method can be carried out, at least in part, by means of a computer or a data processing system.

The training method includes recording a trajectory of the motor vehicle when driving through a section with the driver assistance system for automated lateral guidance deactivated, which section cannot be managed by the driver assistance system for automated lateral guidance.

It is conceivable that the driver assistance system uses lane markings to keep the motor vehicle in the middle of the lane in the manner described above. The section, which can also be referred to as an area, may be a section of road that does not have road marking(s) or lane marking(s). Consequently, the driver assistance system cannot be used in such an area, which does not have lane marking(s), before the training method is carried out.

A trajectory can be understood as a path along which the motor vehicle moves or has moved through the section. It is conceivable that the trajectory has a temporal component in addition to position information, i.e., when was the motor vehicle where and/or at what speed and/or acceleration did the motor vehicle drive at which position.

Recording the trajectory can include storing the trajectory, for example, in the motor vehicle. The recording of the trajectory can be done by means of a sensor system, for example, including a camera, a LiDAR sensor, an ultrasonic sensor, a wheel speed sensor, an accelerometer, a yaw rate sensor and/or a radar sensor.

The trajectory can also be defined as a path of motion of the motor vehicle. This can be detected by means of motion sensors of the motor vehicle, for example the wheel speed sensors, the acceleration sensor and/or the yaw rate sensor. In order to locate this trajectory in reality, the motor vehicle can be positioned. This can be done by means of a GNSS system or in addition or alternatively also by means of landmarks, which can be detected, for example, by means of the mentioned environment sensors (for example, camera, LiDAR sensor, ultrasonic sensor and/or radar sensor).

In addition, it can be recorded which payment system the motor vehicle uses when driving through the section and/or whether there are other restrictions (for example, a height restriction).

It is also conceivable that when driving through or recording the trajectory with the help of the environment sensors, a free space or a road width is recorded, for example, a width of a lane for passing through the section. This can be used to determine the speed of the motor vehicle when the trained driver assistance system is later driven through the section in an automated manner, i.e., a speed can be adjusted to match a speed specified for this road width, in particular the width of the lane.

The training method also includes training the driver assistance system for automated lateral guidance based on the recorded trajectory, so that the section is manageable for the driver assistance system for automated lateral guidance after the training.

The training method is not limited to one passage of the section, but multiple passages can also be made. This means that multiple trajectories can be recorded and these multiple trajectories can be used to train the driver assistance system.

The training method offers the advantage that the driver assistance system can be functionally extended so that it can be used after the training method in driving situations or on (route) sections where it could not be used before the training method. The motor vehicle can thus determine which path or trajectory it can or should use according to the training method. The method can be carried out by the motor vehicle itself and/or supported by the data of multiple vehicles in a cloud, i.e., no human development work is required for the functionality expansion. In addition, it is conceivable that driver assistance systems of other motor vehicles will also receive the improved driver assistance system, for example, via overhead car-to-car communication and/or via a cloud (for example, over-the-air update and/or vehicle-to-infrastructure transmission).

In the following, possible developments of the method described above are explained in detail.

The training method can include determining that the section on a planned route of the motor vehicle is at a predetermined distance from the motor vehicle that cannot be managed by the driver assistance system for automated lateral guidance, driving the motor vehicle with the activated driver assistance system for automated lateral guidance until the time of determining that the section on the planned route of the motor vehicle which cannot be managed by the driver assistance system for automated lateral guidance is at the predetermined distance from the motor vehicle, and deactivating the driver assistance system for automated lateral guidance by issuing a takeover request by means of the motor vehicle before the section is reached by the motor vehicle.

The training method may include recording another trajectory of another motor vehicle as it drives through the section with the driver assistance system for automated lateral guidance deactivated, and training the driver assistance system for automated lateral guidance based on the further recorded trajectory so that the driver assistance system for automated lateral guidance can manage the section after the training.

The training method can include a plausibility check of the trajectory of the motor vehicle using the trajectory of the other motor vehicle, and training the driver assistance system for automated lateral guidance based on the plausibility-verified trajectory of the motor vehicle, so that the driver assistance system for automated lateral guidance can manage the section after training.

Training the driver assistance system for automated lateral guidance can include determining a passage trajectory or drive-through trajectory for the section starting from a first predetermined lane to a second predetermined lane.

In other words, instead of the lane markings, the driver assistance system can now use a fixed trajectory, the so-called passage trajectory, as a guide variable along which the motor vehicle should or can drive in the section controlled by the driver assistance system.

Furthermore, the disclosure relates to a use of the driver assistance system trained by the training method described above to control the lateral guidance of a motor vehicle.

Before and/or during a passage through the section, the driver assistance system can be used to check whether an environment (for example, height restrictions, payment system, etc.) and/or a condition of the motor vehicle (for example, driving with or without a trailer) has changed in a predetermined way compared to the time when the driver assistance system was trained, and if the environment and/or the condition of the vehicle has changed in a predetermined way compared to the time when the driver assistance system was trained, the driver assistance system cannot be used.

The above description with reference to the training method also applies analogously to the use and vice versa.

In other words, and referring to a specific design which is described as not limiting the present disclosure, the above description is summarized as follows:

A driver of a motor vehicle can be shown that there is a section in front of him, for example a toll station, but that it cannot (yet) be driven through.

The driver can then be offered to teach the section or in particular the toll station to the system by driving through it manually once or multiple times.

If the driver manually drives through the section or in particular the toll station, then the driver assistance system can record a driven trajectory together with information about a starting lane (i.e., a lane in which the motor vehicle is located before reaching the section), a selected destination lane (i.e., a lane on which the motor vehicle is located after the section), and the route that the driver drove (so-called trajectory). Which road boundaries exist in or on the section, which trajectories other vehicles have taken and/or whether the motor vehicle was able to drive through the section with or without a payment stop and, optionally, which vehicle-integrated payment system was used, can also be stored.

If a sufficient amount of and/or accurate data has been collected after one or more passes through the section with the motor vehicle, then a map can also be created with the vehicle specific trajectories and, if appropriate, with the trajectories of the other vehicles, in which the trajectories are plausibility checked against each other.

If there is a sufficiently plausible trajectory, which can also be referred to as a drive-through lane, from the current starting lane to the destination lane, then this can be used by the driver assistance system to steer the motor vehicle through the section.

If a sufficiently plausible trajectory has been learned, then it is also or alternatively conceivable to upload it to a cloud and make it available to other or further vehicles, for example, via an online service and/or via an improved or updated map version.

In a possible design, it is conceivable that at a predetermined distance before the section the driving assistance system offers the driver to drive the motor vehicle through the section. The driver can confirm or reject this and continue to train the driver assistance system. However, it is also conceivable that good training quality is assumed and the confirmation by the driver before the toll station may be omitted if the motor vehicle has driven through the section multiple times without driver intervention.

In a further possible additional or alternative design, it is conceivable that changes to the vehicle (so-called condition of the motor vehicle), such as an attached trailer, or a modification of an infrastructure (so-called environment), such as a payment option that has been omitted but was previously used at this lane, can result in the drive-through lane learned or specified in the manner described above being discarded.

A data processing system is also provided. The system is characterized in that it is designed to carry out at least part of the method described above.

The system may include a data processing device in a vehicle. This can be, for example, an electronic control unit or control device (ECU=electronic control unit). The electronic control unit can be an intelligent processor-controlled unit that can communicate with other modules, for example, via a central gateway (CGW), and which, if necessary, can form the vehicle electrical system via fieldbuses, such as the CAN bus, LIN bus, MOST bus and FlexRay or via automotive ethernet, for example together with telematics control units. It is conceivable that the control unit controls functions relevant to the driving behavior of the motor vehicle, such as the engine control system, the power transmission, the braking system and/or the tire pressure monitoring system, and/or can access the relevant data. In addition, driver assistance systems, such as parking assistant, adaptive cruise control (ACC), lane departure warning, lane change assistant, traffic sign recognition, light signal recognition, starting assistant, night vision assistant, emergency brake assistant and/or intersection assistant, can be controlled by the control unit and/or relevant data can be accessed.

In addition, a vehicle, a motor vehicle (in particular an automated one), may be provided with the data processing device. The vehicle is characterized in that it has the data processing device.

The motor vehicle may be a passenger car, in particular an automobile, and/or a commercial vehicle. The automated motor vehicle may be designed to take over longitudinal guidance and/or lateral guidance in automated driving of the motor vehicle, at least partially and/or at least temporarily. Automated driving can be carried out in such a way that the movement of the motor vehicle is carried out (largely) autonomously. The automated driving can be controlled at least partly and/or temporarily by the data processing device.

The motor vehicle can be a motor vehicle of autonomy level 0, i.e., the driver takes over the dynamic driving task, even if supporting systems (for example, ABS or ESP) are present.

The motor vehicle can be a motor vehicle of autonomy level 1, i.e., with certain driver assistance systems that support the driver in operating the vehicle, such as adaptive cruise control (ACC).

The motor vehicle can be a motor vehicle of autonomy level 2, i.e., it can be partially automated in such a way that functions such as automatic parking, lane keeping or lateral guidance, general longitudinal guidance, acceleration and/or braking are undertaken by driver assistance systems.

The motor vehicle can be a motor vehicle of autonomy level 3, i.e., conditionally automated so that the driver does not have to continuously monitor the vehicle system. The motor vehicle independently performs functions such as triggering the turn signal, changing lanes and/or lane keeping. The driver can turn to other things, but if necessary, can be requested by the system to take control within a warning time.

The motor vehicle can be a motor vehicle of autonomy level 4, i.e., so highly automated that control of the vehicle is permanently taken over by the vehicle system. If the system can no longer manage the driving tasks, the driver can be asked to take control.

The motor vehicle can be a motor vehicle of autonomy level 5, i.e., so fully automated that the driver is not required to perform the driving task. Other than setting the destination and starting the system, no human intervention is required.

It is conceivable that the data processing device of the motor vehicle collects the data according to the specification based on an output of a sensor system and outputs it to the first and/or the second cloud component.

A cloud component can be understood as a part of a cloud. A cloud can be understood as a system comprising one or more data processing devices, which is connected or connectable to the vehicle, in particular wirelessly.

The description given above with reference to the method also applies analogously to the data processing system and vice versa.

A computer program is also provided. The computer program is characterized in that it includes commands which, when the program is executed by a computer, cause the computer to carry out at least one of the methods described above, at least in part.

A program code of the computer program can be in any code, especially in a code suitable for the controllers of motor vehicles.

In addition, a non-transitory computer-readable medium, in particular a non-transitory computer-readable storage medium, is provided. The computer-readable medium is characterized in that it includes commands which, when the program is executed by a computer, cause it to carry out at least part of one of the methods described above.

This means that a computer-readable medium may be provided, which includes a computer program defined above. The computer-readable medium can be any digital data storage device, such as a USB stick, a hard drive, a CD-ROM, an SD card, or an SSD card. The computer program does not necessarily have to be stored on such a computer-readable storage medium in order to be made available to the motor vehicle, but can also be obtained via the Internet or otherwise externally.

The above description with reference to the methods and the system for data processing also applies analogously to the computer program and the computer-readable medium and vice versa.

In the following, an embodiment is described with reference to FIGS. 1 and 2.

### BRIEF DESCRIPTION OF THE DRAWINGS

FIG. 1 schematically shows a motor vehicle that is designed to carry out a training method for a driver assistance system for the automated lateral guidance of a motor vehicle, as well as its use in a motor vehicle, and

FIG. 2 schematically shows a flow chart of the training method.

### DETAILED DESCRIPTION OF THE DRAWINGS

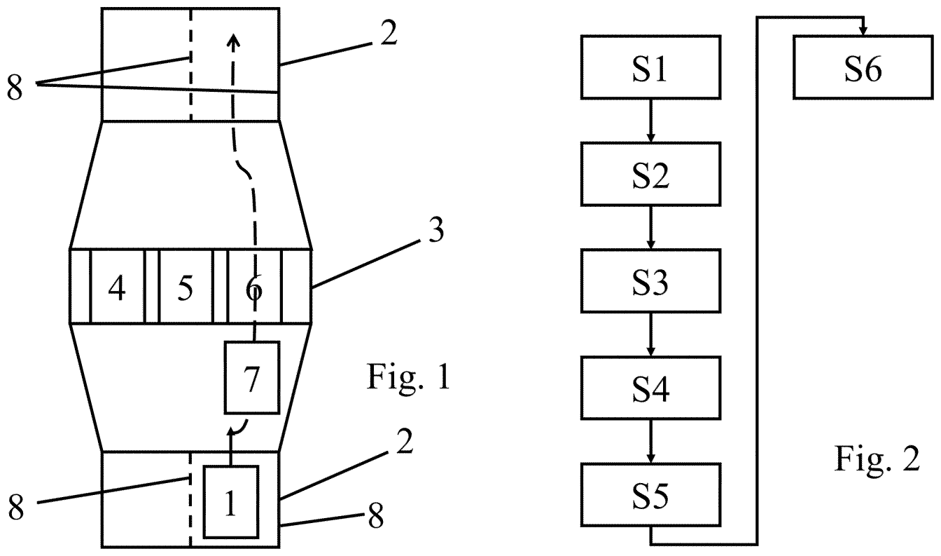

FIG. 1 schematically shows a driving situation in a plan view in which a motor vehicle 1 is on a road 2 with lane markings 8 and, with the driver assistance system activated for automated lateral guidance, is moving behind a vehicle 7 ahead towards a toll station 3 with three passages 4, 5, 6. In the area of the road 2, the driver assistance system uses the lane markings 8 to determine the position of the motor vehicle 1 in a lane and to keep the motor vehicle 1 in the lane by steering interventions. Since the toll station 3 has no lane markings, this is a section that cannot be managed by the driver assistance system for automated lateral guidance. To improve this, the training method for the driver assistance system, the flow diagram of which is shown on the left in FIG. 2 and that has the steps S1-S . . . , is carried out by the motor vehicle 1.

In a first step S1 of the training method, map data are used to determine that the toll station 3, which cannot (at this point in time) be managed by the driver assistance system for automated lateral guidance, is located on a planned route of the motor vehicle 1 (see also direction arrow in FIG. 1) at a predetermined distance from the motor vehicle 1. At the time of determining that the toll station 3 is located ahead of the motor vehicle 1, the driver assistance system for automated lateral guidance is activated.

In a second step S2 of the training method, deactivation of the driver assistance system for automated lateral guidance is carried out by outputting a takeover request by the motor vehicle before the toll station 3 is reached by the motor vehicle 1.

The driver now takes control of the lateral guidance and steers the motor vehicle 1 through the toll station 3 so that it passes through the toll station 3 with the driver assistance system deactivated for automated lateral guidance.

In a third step S3 of the training method, a trajectory of the motor vehicle 1 is detected and recorded when driving through the toll station 3 with the driver assistance system for automated lateral guidance deactivated. In addition, a trajectory of the motor vehicle 7 ahead is detected and recorded when driving through the section with the driver assistance system deactivated for automated lateral guidance. In addition, before and/or during the drive through the toll station 3, an environment (for example, which payment system is used when driving through the toll station 3) and/or a condition of the motor vehicle (for example, a trailer is towed when driving through) is detected and recorded.

In a fourth step S4 of the training method, plausibility is checked, in particular the recorded trajectory of the motor vehicle 1 is compared with the recorded trajectory of the motor vehicle 7 ahead. In the present case, both motor vehicles 1, 7 move through the same passage 6 of the toll station 3 along essentially the same trajectory, as indicated by the dotted line, so that this trajectory is considered plausible. Steps S3 and S4 can be carried out repeatedly by the motor vehicle 1 for the same toll station 3.

In a fifth step S5 of the training method, the driver assistance system for automated lateral guidance is trained based on the plausibility-verified trajectory of the motor vehicle 1, wherein the trajectory obtained and plausibility-verified by means of steps S3 and S4 is defined as a drive-through trajectory for the right-hand lane of the road 2 as the starting lane and the destination lane or is stored in the driver assistance system. The toll station 3 can now be driven through by automatically following the drive-through trajectory using the driver assistance system, so that it is now considered a manageable section.

Consequently, in step S6 driving through the toll station 3 is carried out with the use (see right-hand side in FIG. 2) of the driver assistance system trained with the above training method, wherein the driver assistance system undertakes the control of the lateral guidance of the motor vehicle 1 in such a way that it follows the drive-through trajectory. Before and/or during the drive through the toll station 3 by means of the activated driver assistance system, a check is carried out to ascertain whether the environment and/or the condition of the vehicle has changed in a predetermined way compared to a time of training the driver assistance system (see step S3) (for example, a different means of payment is used or there is no longer a holdup). If, compared to the time the driver assistance system was trained, the environment and/or the condition of the motor vehicle has changed in the predetermined way, the driver assistance system is either not used or the driver is given control of the lateral guidance while driving through the toll station. The learned or stored drive-through trajectory is discarded.

### LIST OF REFERENCE SIGNS

1 Motor vehicle
2 Road
3 Toll station
4-6 Passages
7 Vehicle ahead
8 Lane markings or road markings
S1-S6 Method steps

1.-10. (canceled)

11. A training method for a driver assistance system for automated lateral guidance of a motor vehicle, the training method comprising:
recording a trajectory of the motor vehicle when driving through a section with the driver assistance system for automated lateral guidance deactivated, wherein the section cannot be managed by the driver assistance system for automated lateral guidance; and
training the driver assistance system for automated lateral guidance based on the recorded trajectory, so that the section can be managed by the driver assistance system for automated lateral guidance after the training.

12. The training method according to claim 11, further comprising:
determining that the section lies on a planned route of the motor vehicle at a predetermined distance from the motor vehicle that cannot be managed by the driver assistance system for automated lateral guidance;
driving the motor vehicle with the driver assistance system activated for automated lateral guidance at a time of determining that the section lies on the planned route of the motor vehicle at the predetermined distance from the motor vehicle that cannot be managed by the driver assistance system for automated lateral guidance; and
deactivating the driver assistance system for automated lateral guidance by issuing a takeover request by the motor vehicle before the section is reached by the motor vehicle.

13. The training method according to claim 11, further comprising:
recording another trajectory of another motor vehicle when driving through the section with the driver assistance system for automated lateral guidance deactivated; and
training the driver assistance system for automated lateral guidance based on the further recorded trajectory, so that the section can be managed by the driver assistance system for automated lateral guidance after the training.

14. The training method according to claim 12, further comprising:
recording another trajectory of another motor vehicle when driving through the section with the driver assistance system for automated lateral guidance deactivated; and
training the driver assistance system for automated lateral guidance based on the further recorded trajectory, so that the section can be managed by the driver assistance system for automated lateral guidance after the training.

15. The training method according to claim 13, further comprising:
plausibility checking the trajectory of the motor vehicle with the trajectory of the other motor vehicle; and
training the driver assistance system for automated lateral guidance based on the plausibility-verified trajectory of the motor vehicle so that the driver assistance system for automated lateral guidance can manage the section after the training.

16. The training method according to claim 14, further comprising:
plausibility checking the trajectory of the motor vehicle with the trajectory of the other motor vehicle; and
training the driver assistance system for automated lateral guidance based on the plausibility-verified trajectory of the motor vehicle so that the driver assistance system for automated lateral guidance can manage the section after the training.

17. The training method according to claim 11, wherein the training of the driver assistance system for automated lateral guidance includes specifying a drive-through trajectory for the section starting from a first predetermined lane to a second predetermined lane.

18. The training method according to claim 12, wherein the training of the driver assistance system for automated lateral guidance includes specifying a drive-through trajectory for the section starting from a first predetermined lane to a second predetermined lane.

19. The training method according to claim 13, wherein the training of the driver assistance system for automated lateral guidance includes specifying a drive-through trajectory for the section starting from a first predetermined lane to a second predetermined lane.

20. The training method according to claim 17, wherein the training of the driver assistance system for automated lateral guidance includes specifying a drive-through trajectory for the section starting from a first predetermined lane to a second predetermined lane.

21. The training method according to claim 11, further comprising:
controlling the lateral guidance of the motor vehicle based on the training of the driver assistance system.

22. The training method according to claim 21, wherein before and/or during a drive through the section a check is carried out by the driver assistance system to determine whether an environment and/or a condition of the motor vehicle has changed in a predetermined manner compared to the time when the driver assistance system was trained, and if, compared to a time of training the driver assistance system, the environment and/or condition of the motor vehicle has changed in the predetermined manner, the driver assistance system is not used.

23. A system for data processing, comprising a data processor configured to for carry out a method according to claim 11.

24. The system according to claim 23, wherein the data processor is configured to:
determine that the section lies on a planned route of the motor vehicle at a predetermined distance from the motor vehicle that cannot be managed by the driver assistance system for automated lateral guidance;
drive the motor vehicle with the driver assistance system activated for automated lateral guidance at a time of determining that the section lies on the planned route of the motor vehicle at the predetermined distance from the motor vehicle that cannot be managed by the driver assistance system for automated lateral guidance; and
deactivate the driver assistance system for automated lateral guidance by issuing a takeover request by the motor vehicle before the section is reached by the motor vehicle.

25. A non-transitory computer-readable medium storing commands which, when executed by a computer, cause the computer to carry out a method according to claim 11.

26. The non-transitory computer-readable medium according to claim 25, further comprising commands that cause the computer to:
determine that the section lies on a planned route of the motor vehicle at a predetermined distance from the motor vehicle that cannot be managed by the driver assistance system for automated lateral guidance;
drive the motor vehicle with the driver assistance system activated for automated lateral guidance at a time of determining that the section lies on the planned route of the motor vehicle at the predetermined distance from the motor vehicle that cannot be managed by the driver assistance system for automated lateral guidance; and
deactivate the driver assistance system for automated lateral guidance by issuing a takeover request by the motor vehicle before the section is reached by the motor vehicle.
